(19) United States
(12) Patent Application Publication
(10) Pub. No.: US 2022/0024201 A1
(43) Pub. Date: Jan. 27, 2022

(54) PRINTING COMPENSATION

(71) Applicant: Hewlett-Packard Development Company, L.P., Spring, TX (US)

(72) Inventors: Javier Castro Soriano, Sant Cugat del Valles (ES); Ruben Recasens Oros, San Diego, CA (US); Jordi Bas Ferrer, Sant Cugat del Valles (ES)

(21) Appl. No.: 17/311,053

(22) PCT Filed: Dec. 17, 2018
(86) PCT No.: PCT/US2018/066064

§ 371 Date: Jun. 4, 2021

(51) Int. Cl. B41J 2/045

(52) U.S. Cl. CPC B41J 2/04505; B41J 2/04586

(57) ABSTRACT

In an example, a method for compensating a misalignment introduced by a printing process comprises printing a plurality of first symbols onto a print media with a first printing liquid at spaced-apart locations on the print media, printing a plurality of second symbols onto the print media with a second printing liquid such that each second symbol overlaps a corresponding first symbol by a different symbol offset amount, identifying a first symbol and the corresponding second symbol, and the respective symbol offset amount, that represent a correct alignment between the plurality of first symbols and the plurality of second symbols, and adjusting a print parameter according to the identified symbol offset amount.

### BACKGROUND

Visible misalignment between layers of printing liquid printed onto print media can degrade printing quality. Methods and systems to reduce such misalignment are desirable.

### BRIEF DESCRIPTION OF THE DRAWINGS

Various features and advantages of the present disclosure will be apparent from the detailed description which follows, taken in conjunction with the accompanying drawings, which together illustrate, by way of example only, features of the present disclosure, and wherein:

FIG. 1 is a flow diagram of a method according to an example;

FIG. 2 is a schematic view of a verification plot according to an example;

FIG. 3 is a schematic view of a verification plot according to an example;

FIG. 4 is a flow diagram of a method according to an example; and

FIG. 5 is a schematic view of a printing system according to an example.

### DETAILED DESCRIPTION

Printing an image on a print media may comprise printing a first part or layer using a first printing liquid and then printing a second part or layer using a second printing liquid to overlie the first printing liquid. More than two printing liquids may be used for other parts and/or layers of the image. Examples of printing in layers include using a layer as an undercolor layer and using a layer as overcolor layer. In undercolor, a first printing liquid is printed as a base and a second liquid is printed onto the first printing liquid to form an image to be printed. The first printing liquid may help to provide a high print quality of the image to be printed over a wide variety of print media substrates. In overcolor, the first printing liquid may be printed, e.g., on to a transparent print media to form the image to be printed, and the second printing liquid may be printed onto the first printing liquid, for example to protect the first printing liquid. A second printing liquid may provide a background to the first printing liquid. A background may help the color of the first printing liquid to be reproduced properly. In some examples, the one of the first or second printing liquids may be a white printing liquid and the other of the first and second printing liquids may be of a different color. In other examples, the first and second printing liquids may be of the same color but have some other visually identifiable different property. For example, the first printing liquid may be matt and the second printing liquid may be gloss or reflective.

When a second printing liquid is printed upon a first, different printing liquid, visible misalignment of the first and second printing liquids can occur, thus reducing the print quality of an image to be printed. While such misalignment can be caused by misalignment between the different print heads that print the different printing liquids, examples herein relate to misalignment introduced by a printing process to print the image onto print media. It is assumed, therefore, according to examples herein, that print head misalignment has already been corrected or compensated for. Misalignment introduced by a printing process to print the image onto print media may be unpredictable due to differences in material properties of the print media and/or differences in the environmental conditions generated during printing of the image onto the print media. The misalignment may be caused during the printing process by, for example, one or more of: deformation of print media, pre-alignment of printheads not reproducing exact printing conditions generated during the printing process, media advance errors, media skew, scanning misalignment, and airflow induced by systems used during the printing process.

Deformation of a print media may be induced by a process to print an image. For example, a printing process may comprise printing a plurality of layers of a first printing liquid, and drying and/or curing each of those layers, before the second printing liquid is printed onto the layers of the first printing liquid. Elements of the printing process, including one or more of wetting, drying and curing, may cause deformation of the print media, for example due to an increase in temperature and/or humidity at the print media. This may lead to the second printing liquid being misaligned with the plurality of layers of the first printing liquid.

Reference to deformation of a print media as used herein refers to substantially uniform deformation across an entire print media. Deformation may comprise an increase or a decrease in the dimensions of the print media.

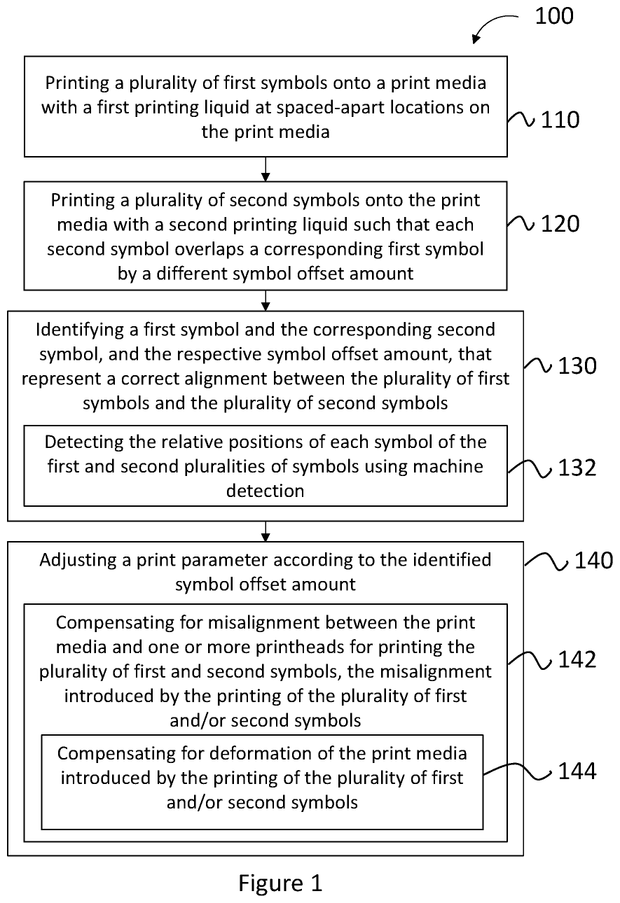

As shown in FIG. 1, an example provides a method 100 for compensating a misalignment introduced by a printing process. The method 100 may allow verification and/or correction of visible misalignment of printing liquids between printing a first printing liquid and printing a second printing liquid. The method 100 comprises printing a plurality of first symbols onto a print media with a first printing liquid at spaced-apart locations on the print media (block 110). The plurality of first symbols may be printed using a print mode, as opposed to a diagnostic mode of a printing system to perform the method 100. A print mode substantially reproduce printing conditions generated during printing of an image on to the print media. The method 100 may comprise printing the plurality of first symbols using a first printing process, to reproduce print conditions generated by printing, with the first printing process, a portion of an image to be printed onto the print media. The first printing process may comprise printing a plurality of layers of the first printing liquid. The first printing process may comprise drying and curing symbols of the plurality first symbols

The method 100 comprises printing a plurality of second symbols printed with a second printing liquid (block 120). The plurality of second symbols may be printed using a print mode, as opposed to a diagnostic mode of the printing system to perform the method 100. The method 100 may comprise printing the plurality of second symbols using a second printing process to reproduce print conditions generated by printing, with the second printing process, a portion of an image to be printed onto the print media. In an example, the second printing process may comprise printing a plurality of layers of the second printing liquid onto the plurality of layers of the first printing liquid. The second printing process may comprise drying and curing symbols of the plurality of second symbols

Together, the plurality of first symbols and the plurality of second symbols form a verification plot. The verification plot may be of a substantially similar size to an image to be printed, so that, for example, printing of the verification plot produces conditions representative of printing of the image to induce potential misalignment that would otherwise occur during printing of the image.

Each second symbol of the plurality of second symbols overlaps a corresponding first symbol of the plurality of first symbols by a different symbol offset amount. The overlap is printed intentionally. By way of example, an initial second symbol may be offset from a corresponding first symbol by a symbol offset amount “a”. Subsequent second symbols may be offset from a respective corresponding first symbol by a symbol offset amount “a+xn” wherein “n” is an incremental increase in the symbol offset amount “a”, and “x” is an integer, for instance, corresponding to the number of a respective symbol after the initial second symbol. For example, “a” and “n” may be equal to a pixel width of a printhead to print the first and/or second printing liquid. The symbol offset amount may comprise a first incremental offset and a second incremental offset.

In some examples, symbols of the plurality of second symbols are printed when the corresponding underlying symbols of the plurality of first symbols have been dried and cured. In some examples, printing the plurality of second symbols (block 120) may commence before printing of the plurality of first symbols (block 110) is complete. For example, a first half of the plurality of first symbols may be printed, dried and cured, and, as the second half of the plurality of first symbols is printed, dried and cured, a first half of the plurality of second symbols maybe printed onto the first half of the plurality of first symbols.

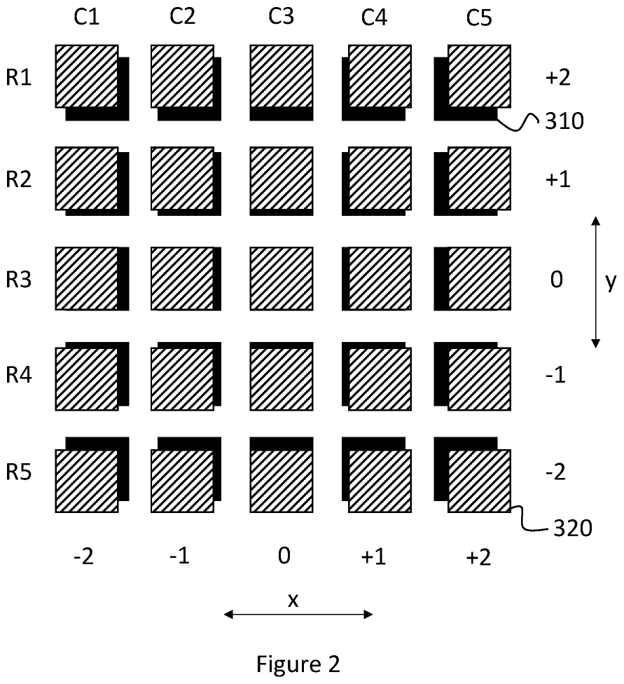

FIG. 2 shows a schematic view of an example of a plurality of first symbols 310, denoted by a plurality of black squares, and a plurality of second symbols 320, denoted by a plurality of hatched squares, each printed according to an example of the method 100. Each second symbol of the plurality of second symbols 320 overlaps a corresponding first symbol of the plurality of first symbols 310 by a different offset amount. In this example, it may be assumed for the purposes of illustration that the pluralities of symbols 310, 320 have been printed on a print media wherein misalignment has not occurred during printing of the first and second pluralities of symbols 310, 320. In this example, the plurality of symbols of the first and second pluralities of symbols 310, 320 are each arranged in a matrix comprising five rows R1-R5 and five columns C1-C5. Other examples may comprise more or fewer rows and/or columns. Yet other examples may comprise a non-uniform pattern of symbols.

To the right and below the first and second pluralities of symbols 310, 320 of FIG. 2 are shown the symbol offset amounts of the second symbols in the respective row R1-R5 or column C1-C5, relative to the corresponding first symbol. In this example, for each column C1-C5, the symbol offset amount changes by a first incremental amount in a first direction, denoted by arrow x in FIG. 2. For each row R1-R5, the symbol offset amount changes by a second incremental amount in a second direction, denoted by arrow y in FIG. 2. As such, in this example, each of the plurality of second symbols is offset relative to the corresponding first symbol by a different symbol offset amount comprising a first incremental offset amount and a second incremental offset amount. In some examples, the first and second incremental amounts are substantially equal for a particular second symbol. In some examples, the first and/or second incremental amounts may be zero, for example as shown for second symbols in R3, which have a second incremental amount equal to zero.

In this example, the central symbol of the plurality of second symbols 320 (located at coordinate R3, C3) is aligned with the corresponding symbol of the plurality of first symbols 310. Each of the remaining symbols of the plurality of second symbols 320 are intentionally misaligned with the respective corresponding symbol of the plurality of first symbols 310 in the x and y directions by the same number of incremental amounts as the number of rows or columns that the respective symbol is away from the central symbol. In this example, the top right symbol of the plurality of second symbols 320 (located at coordinate R1, C5) is misaligned by +2 multiples of the first incremental amount in the x-direction, and +2 multiples of the second incremental amount in the y-direction.

In some examples, the first and/or second incremental amounts may be substantially equal to the minimum compensation amount that can be achieved by a printing system to perform the method 100. In some examples, the first and/or second incremental amounts may be substantially equal to a pixel width of a printhead, or printheads, for printing the first and second printing liquids. In some examples, the first and/or second incremental amounts may be equal to a smallest visually detectable increment that is detectable by an appropriate optical detector. In some examples, the first and/or second incremental amounts may be equal to a smallest increment of media advancement relative to printheads that is achievable by a printing system to perform the method 100.

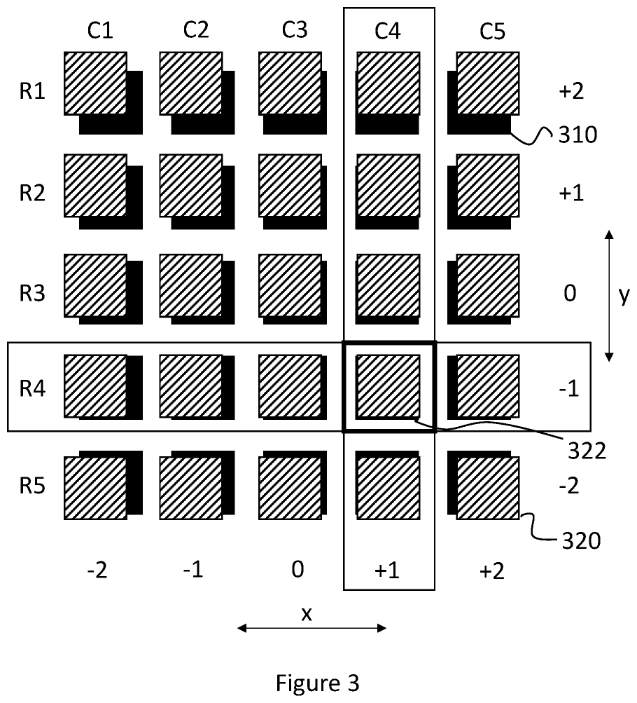

In some examples, each symbol in the pluralities of first and second symbols has a height and a width. Each second symbol is offset from the corresponding first symbol by a first amount in a height direction and a second amount in a width direction perpendicular to the height direction, so that each of the plurality of second symbols is offset relative to the corresponding first symbol by a different symbol offset amount. Each symbol offset amount comprises the first amount and the second amount for the respective second symbol. In the example shown in FIGS. 2 and 3, the symbols of the first and second pluralities of symbols are squares. In other examples, different symbols may be used, for example, polygons having a different number of sides, or a line (or lines). In this example, the symbols in the plurality of first symbols and the plurality of second symbols are identical in shape. In other examples, the second symbols may be different to the first symbols. In yet other examples, the plurality of first symbols may comprise different symbols and each of the plurality of second symbols may be the same as a corresponding symbol of the plurality of first symbols.

In some examples of the method 100, comprising printing the plurality of first symbols with a first printhead and printing the plurality of second symbols with a second printhead, the first and second printheads are pre-aligned. That is, the first and second printheads are aligned with respect to one another prior to printing the respective pluralities of first and second symbols. The method 100 is thus performed to compensate for misalignment between the print media and the first and second printheads that is introduced by printing of the plurality of first symbols and/or the printing of the plurality of second symbols. For example, the misalignment may be caused by media deformation due to printing conditions generated during the printing of the method 100.

In some examples, the first and second printing liquids comprise latex. In some examples, the first and second printing liquids are different colors. In some examples, the first and second printing liquids are of different opacities. In some examples, the first printing liquid is white and the second printing liquid is a color other than white, or vice versa. In other examples, the first and second printing liquids may be of the same color but have some other visually identifiable different property. For example, the first printing liquid may be matt and the second printing liquid may be reflective, or vice versa.

Referring back to FIG. 1, the method 100 comprises identifying a first symbol and the corresponding second symbol, and the respective symbol offset amount, that represent a correct alignment between the plurality of first symbols and the plurality of second symbols (block 130). Identifying the first and second symbol that represent correct alignment may be by visual inspection of the first and second pluralities of symbols, for example by an operator of a printing system to perform the method 100. In some examples, the visual inspection may be performed by detecting the relative position of each symbol of the first and second pluralities of symbols (block 132), for example by using machine detection (block 132), such as, comprising an appropriate optical sensor and computer program logic. In some examples, the identified first and second symbols are the first and second symbols that most accurately overlie one another. In some examples in which each symbol has a height and a width, the identifying comprises detecting the symbol offset amount, for each second symbol, in the height direction and/or the width direction. In the example shown in FIG. 2, the central symbol (located at coordinate R3, C3) of the plurality of second symbols 320 is the second symbol that most accurately overlies the corresponding first symbol.

FIG. 3 shows a schematic view of an example of a plurality of first symbols 310, denoted by a plurality of black squares, and a plurality of second symbols 320, denoted by a plurality of hatched squares. FIG. 3 is substantially similar to FIG. 2 except that, in this case, printing liquid misalignment has occurred as a result of printing the first and second pluralities of symbols. The misalignment has caused misalignment between the first and second pluralities of symbols 310, 320 so that the central symbol (located at coordinate R3, C3) of the plurality of second symbols 320 is not aligned with the corresponding symbol of the plurality of first symbols 310.

The plurality of second symbols are printed over the plurality of respective corresponding first symbols such that they overlap. In this example, the symbols 322 located at coordinate R4, C4 are identified as representing a correct alignment between the first and second pluralities of symbols 310, 320. In this example, the identified first and second symbols are the first and second symbols that most accurately overlie one another. In other examples, the identified first and second symbols may be the first and second symbols that are offset relative to one another by a predetermined amount. In this example, the symbol offset amount of the identified symbol 322 is −1 multiple of the second incremental amount in the y-direction, and +1 multiple of the first incremental amount in the x-direction.

In some examples, each symbol of the plurality of second symbols 320 has a unique reference number, and the method 100 comprises looking up the reference number of the identified symbol to identify the associated symbol offset amount.

Referring back to FIG. 1, the method 100 comprises adjusting a print parameter according to the identified symbol offset amount (block 140). In some examples, the amount of adjusting is substantially equal to the symbol offset amount. In other examples, the amount of adjusting is based on the symbol offset amount. In some examples, adjusting the print parameter comprises compensating for misalignment between the print media and one or more printheads for printing the plurality of first and second symbols, the misalignment introduced by the printing of the plurality of first and/or second symbols (block 142). In some examples, the compensating for misalignment between the print media and the one or more printheads comprises compensating for deformation of the print media introduced by the printing of the plurality of first and/or second symbols (block 144). In some examples, the compensating for misalignment between the print media and the one or more printheads comprises compensating for other causes of misalignment introduced by the printing of the plurality of first and/or second symbols, such as, for example, media advance errors, media skew, scanning misalignment, and airflow induced by systems used during the printing of the method 100.

In some examples, in which each symbol of the plurality of second symbols 320 has a unique reference number, the reference number may be associated with a print parameter adjustment value and the adjusting may be performed in accordance with the adjustment value.

In some examples, the method 100 may comprise adjusting a first print parameter to compensate for the symbol offset amount in the x-direction and adjusting a second print parameter to compensate for the symbol offset amount in the y-direction.

In some examples, adjusting a print parameter comprises adjusting the timing between first printing liquid being deposited from a first printhead and second printing liquid being deposited from a second printhead. Such an adjustment may provide the determined offset amount for misalignment introduced by a printing process.

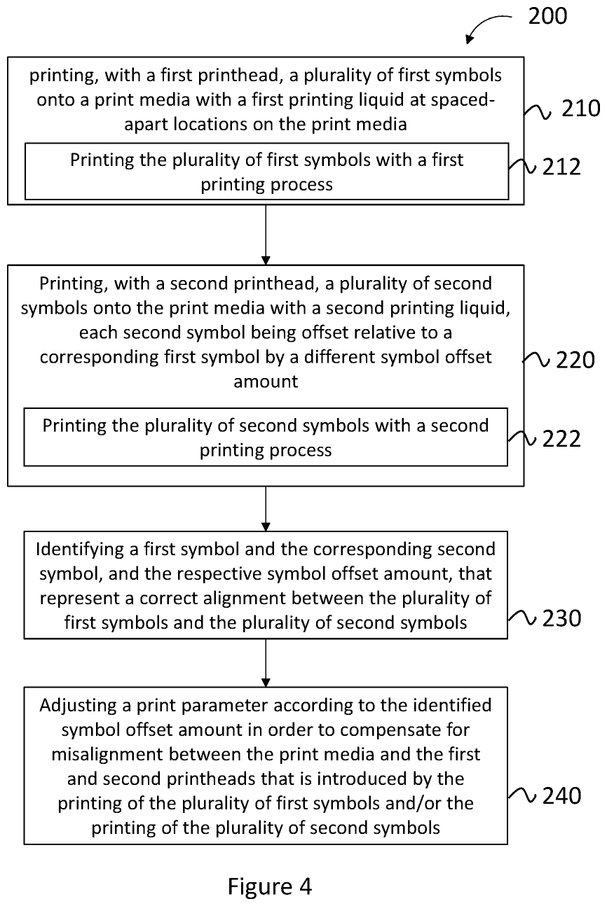

FIG. 4 is a flow diagram showing a method 200 according to an example. The method 200 comprises printing, with a first printhead, a plurality of first symbols onto a print media with a first printing liquid at spaced-apart locations on the print media (block 210). In some examples, the printing of the plurality of first symbols comprises printing a plurality of layers of first printing liquid. The plurality of first symbols may have a form as described with reference to the plurality of symbols 310 of FIG. 2.

The method 200 comprises printing, with a second printhead, a plurality of second symbols onto the print media with a second printing liquid, each second symbol being offset relative to a corresponding first symbol by a different symbol offset amount (block 220). In some examples, each different offset amount comprises a first offset amount in a first direction and a second offset amount in a second direction. The first and second directions may be perpendicular to one another and extend across a print media. For example, the first direction may be parallel to a scanning direction of a printhead and the second direction may be parallel to a media advance direction. The second printhead is different to the first printhead. In some examples, the printing of the plurality of second symbols comprises printing a plurality of layers of second printing liquid. The printing liquid may be a second printing liquid different to the first printing liquid. The plurality of second may have a form as described with reference to the plurality of symbols 320 of FIG. 2.

The method 200 comprises identifying a first symbol and the corresponding second symbol, and the respective symbol offset amount, that represent a correct alignment between the plurality of first symbols and the plurality of second symbols (block 230), as described with reference to the method 100 shown in FIG. 1. In some examples, the method 200 comprises detecting which symbol of the plurality of second symbols is most closely aligned to a corresponding first symbol, for example as described with reference to FIG. 1.

The method 200 comprises adjusting a print parameter according to the identified symbol offset amount in order to compensate for misalignment between the print media and the first and second printheads that is introduced by the printing of the plurality of first symbols and/or the printing of the plurality of second symbols (block 240). For example, such misalignment may be caused by deformation of the print media that occurs as a result of printing the plurality of first symbols and/or the printing of the plurality of second symbols.

In some examples of the method 200, the plurality of first symbols are printed via a first printing process (block 212) and the plurality of second symbols are printed via a second printing process (block 222). The first and second printing processes may be comprised in a process for printing an image to be printed on the print media. In some examples, the misalignment between the print media and the first and second printheads is caused by printing with the first and/or second printing process. In some examples, the first printing process and may comprise drying and curing a plurality of layers of the first printing liquid. In some examples, the printing via the first printing process may cause, for example, media deformation. In some examples, the second printing process may comprise drying and curing a plurality of layers of the second printing liquid. In some examples, the printing via the second printing process may cause, for example, media deformation.

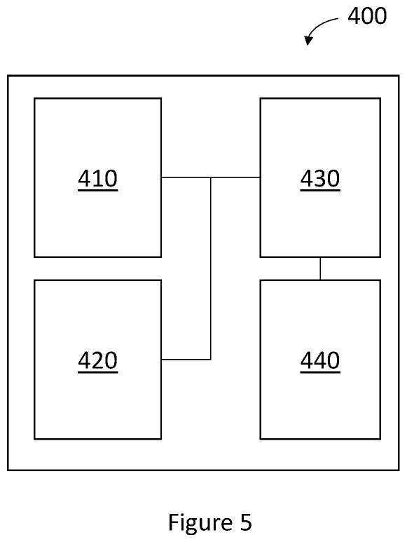

FIG. 5 shows a schematic view of a printing system 400 according to an example. The printing system 400 comprises a first printhead 410 to print a first printing liquid and a second printhead 420 to print a second printing liquid. The second printhead 420 is aligned with the first printhead 410. In other examples, the printing system 400 comprises a single printhead to print the first and second printing liquids. The first and second printing liquids may be of different colors, or may be of the same color but have some other visually detectable difference.

In some examples, the printing system 400 may comprise one or more drying apparatus and/or one or more curing apparatus (not shown), to dry and/or cure the first and second printing liquids printed by the first and second printheads 410, 420.

The printing system 400 comprises a controller 430 to cause the first printhead 410 to print a first plurality of symbols at spaced-apart locations on a print media (not shown) using a first printing process, wherein the first printing process introduces misalignment between layers of printing liquid. The first plurality of symbols may be as described with reference to the plurality of first symbols 310 of FIG. 2.

The controller 430 is to cause the second printhead 420 to print a second of plurality of symbols using a second printing process. Each of the second plurality of symbols overlaps a corresponding symbol of the first plurality of symbols by a different symbol offset amount. The second printing process may introduce misalignment between layers of printing liquid. The second plurality of symbols may be as described with reference to the plurality of second symbols 320 of FIG. 2.

The controller 430 is to adjust a print parameter of the first and/or second printing process according to a symbol offset amount of the symbol of the second plurality of symbols that represents a correct alignment between the first plurality of symbols and the second plurality of symbols. The adjustment thus compensates for printing liquid misalignment caused at least by printing with the first printhead 410 via the first printing process.

In some examples, the printing system 400 comprises a detector 440 to detect alignment between images printed by the first printhead 410 and images printed by the second printhead 420. In such examples, the controller 430 is to cause the detector 440 to identify a first symbol and a corresponding second symbol, that represent a correct alignment between the first and second pluralities of symbols. In some examples, the detector 440 is to send a signal to the controller 430 representing an offset amount of the identified symbol and the controller 430 is to determine an adjusted print parameter based on the received offset amount. In other examples, the detector 440 is to send a signal to the controller 430 representing a reference number associated with the identified symbol and the controller 430 is to determine an adjusted print parameter based on the received reference number, for example by using look-up tables.

In other examples, the detector 440 may be omitted and detecting alignment between images printed by the first printhead 410 and images printed by the second printhead 420 is performed manually. An operator may identify the symbol that represents a correct alignment between the first and second pluralities of symbols and input into the printing system 400 a signal representative of the identified symbol, the signal being received by the controller 430.

In some examples, the print media may be a rigid material such as aluminum, acrylic, pvc foam and wood. In some examples, the print media may be a flexible material such as polyester film or self-adhesive vinyl.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A method for compensating a misalignment introduced by a printing process, comprising:
printing a plurality of first symbols onto a print media with a first printing liquid at spaced-apart locations on the print media;
printing a plurality of second symbols onto the print media with a second printing liquid such that each second symbol overlaps a corresponding first symbol by a different symbol offset amount;
identifying a first symbol and the corresponding second symbol, and the respective symbol offset amount, that represent a correct alignment between the plurality of first symbols and the plurality of second symbols; and
adjusting a print parameter according to the identified symbol offset amount.

2. The method according to claim 1, wherein adjusting the print parameter comprises compensating for misalignment between the print media and one or more printheads for printing the plurality of first and second symbols, the misalignment introduced by the printing of the plurality of first and/or second symbols.

3. The method according to claim 2, wherein the compensating for misalignment between the print media and the one or more printheads comprises compensating for deformation of the print media introduced by the printing of the plurality of first and/or second symbols.

4. The method according to claim 1, wherein the identifying comprises detecting the relative positions of each symbol of the first and second pluralities of symbols using machine detection.

5. The method according to claim 1, wherein the identified first and second symbols are the first and second symbols that most accurately overlie one another.

6. The method according to claim 1, wherein the first and second pluralities of symbols are each arranged in a matrix comprising a plurality of rows and columns, and
wherein, for each column, the symbol offset amount changes by a first incremental amount in a first direction and, for each row, the symbol offset amount changes by a second incremental amount in a second direction, so that each of the plurality of second symbols is offset relative to the corresponding first symbol by a different symbol offset amount comprising a first incremental offset and a second incremental offset.

7. The method according to claim 1, comprising printing the plurality of first symbols using a first printing process to reproduce printing conditions generated by printing, with the first printing process, a portion of an image to be printed onto the print media.

8. The method according to claim 7, wherein the first printing process comprises printing a plurality of layers of the first printing liquid.

9. The method according to claim 7, wherein the first printing process comprises drying and curing symbols of the plurality of first symbols, and wherein symbols of the plurality of second symbols are printed when the corresponding underlying symbols of the plurality of first symbols have been dried and cured.

10. The method according to claim 1, wherein each symbol in the pluralities of first and second symbols has a height and a width, and
wherein each second symbol is offset from the corresponding first symbol by a first amount in a height direction and a second amount in a width direction perpendicular to the height direction, so that each of the plurality of second symbols is offset relative to the corresponding first symbol by a different symbol offset amount, each symbol offset amount comprising the first amount and the second amount for the respective second symbol.

11. The method according to claim 10, wherein the identifying comprises detecting the symbol offset amount, for each second symbol, in the height direction and/or the width direction.

12. A method, comprising:
printing, with a first printhead, a plurality of first symbols onto a print media with a first printing liquid at spaced-apart locations on the print media;
printing, with a second printhead, a plurality of second symbols onto the print media with a second printing liquid, each second symbol being offset relative to a corresponding first symbol by a different offset amount;
identifying a first symbol and the corresponding second symbol, and the respective symbol offset amount, that represent a correct alignment between the plurality of first symbols and the plurality of second symbols; and
adjusting a print parameter according to the identified symbol offset amount in order to compensate for misalignment between the print media and the first and second printheads that is introduced by the printing of the plurality of first symbols and/or the printing of the plurality of second symbols.

13. A method according to claim 12, wherein the plurality of first symbols are printed via a first printing process and the plurality of second symbols are printed via a second printing process, wherein the first and second printing processes are comprised in a process for printing an image to be printed on the print media, and
wherein the misalignment between the print media and the first and second printheads is caused by printing with the first and/or second printing process.

14. A printing system comprising:
a first printhead to print a first printing liquid,
a second printhead to print a second printing liquid, the second printhead being aligned with the first printhead, and
a controller to cause:
the first printhead to print a first plurality of symbols at spaced-apart locations on a print media using a first printing process, wherein the first printing process introduces misalignment between layers of printing liquid, and
the second printhead to print a second of plurality of symbols using a second printing process such that each of the second plurality of symbols overlaps a corresponding symbol of the first plurality of symbols by a different symbol offset amount,
wherein the controller is to adjust a print parameter of the first and/or second printing process according to a symbol offset amount of the symbol of the second plurality of symbols that represents a correct alignment between the first plurality of symbols and the second plurality of symbols.

15. The printing system of claim 14, comprising a detector to detect alignment between images printed by the first printhead and images printed by the second printhead,
wherein the controller is to cause the detector to identify a first symbol and a corresponding second symbol that represent a correct alignment between the first and second pluralities of symbols.
